(19) United States
(12) Patent Application Publication
(10) Pub. No.: US 2004/0194391 A1
(43) Pub. Date: Oct. 7, 2004

(54) Profiled section for plastic rails designed for motor vehicle window lifts

(76) Inventor: Melchor Daumal Castellon, Barcelona (ES)

Correspondence Address: Edward A Meilman, Dickstein Shapiro Morin & Oshinsky, 41st Floor, 1177 Avenue of the Americas, New York, NY, 10036-2714, US

(21) Appl. No.: 10/483,050

(22) PCT Filed: May 6, 2003
(86) PCT No.: PCT/ES03/00197

(30) Foreign Application Priority Data
Jun. 6, 2002 (ES) U200201452

(51) Int. Cl. E05F 11/38

(52) U.S. Cl. 49/374; 49/372; 49/348

(57) ABSTRACT

The section member slidingly receives outwardly a driving member extending through the rail provided with a clamp for holding the lower edge of the window pane. The section member of the rail comprises a longitudinal base portion and a longitudinal portion abutting said driving member having an essentially U-shaped symmetrical cross-section between which branches an extension of said driving member is fitted to avoid relative rotating movements. The base portion has a suitable thickness to bring the two free ends of the driving member in abutting relationship with the lower portion of said second longitudinal portion.

A configuration of multiple areas of contact between the driving member section and the section of the section member is obtained, the section member being symmetric for balancing of loads in the driving member/rail assembly thus avoiding their relative rotation.

The main parts of the power window devices for motor vehicles of the state of the art are basically a movable window pane, driving means for said window pane and gripping means therefor. Said gripping means for the window pane includes at least one clamp that holds it through its lower edge and which is attached either fixed or allowed to be moved to a driving member or sliding member running along a guiding rail.

Said rail is usually an open section member having a reversed U-shaped cross-section inside of which the sliding member extends which is driven by a driving cable. The main disadvantage found on the standard section members used hitherto in power window devices for motor vehicles is that unwanted relative rotating movements take place between the rail and the sliding member, which adversely influence operation of the power window devices.

In this sense, the invention provides a section member for rails in power window devices of motor vehicles specially designed to engage the sliding member of the power window device increasing the number of areas of contact between both elements and thus maintaining the load stability by means of symmetry in the geometry thereof. Said disadvantage is solved by such section member providing the advantage that it is very simple of manufacturing, which positively influences the final cost of the power window device.

The section member of the present invention comprises a first longitudinal base portion and a second longitudinal portion abutting said sliding member. Said section member is made of plastic material, for example, PA (polyamide), POM (polyacetal), PBT, PS (polyester), polypropylene (PP) with 30% of glass fiber, polyethylene (PE) with 30% of glass fiber), or any other suitable plastic material or covered (cold painted or flamed).

The main feature of the section member of the invention is that the second longitudinal portion of the section member has an essentially U-shaped symmetrical cross-section. An extension of said sliding member extends between the branches of said U. During movement of relative sliding of the sliding member along the rail of the power window device, the extension avoids relative rotating movements which could adversely affect the overall operation of the assembly.

On the other hand, the first longitudinal base portion has a suitable thickness to bring the two free ends of the driving member into abutting relationship with the lower portion of said second longitudinal portion. Said free ends close the section of the driving member leaving only the necessary space so that the first portion of the section member may be arranged. The cable terminal is fitted in the sliding member at the central portion thereof, so that the section of the rail is hollow so that the cable may be placed therein.

With this simple configuration six contact areas between the section of the driving member and the section of the section member are obtained. This feature is extremely important as the symmetry of the section member allows for balancing of loads in the driving member/rail assembly thus avoiding their relative rotation.

According to the invention, a driving cable of the driving member or sliding member extends through a groove provided in the extension of said driving member.

A preferred embodiment of a section member for plastic rails for power window devices in motor vehicles according to the present invention will be now described in detail and by way of a non limitative example, from which the features and the advantages thereof will be clearer. The description that follows is given with reference to the drawings that are herein accompanied, in which:

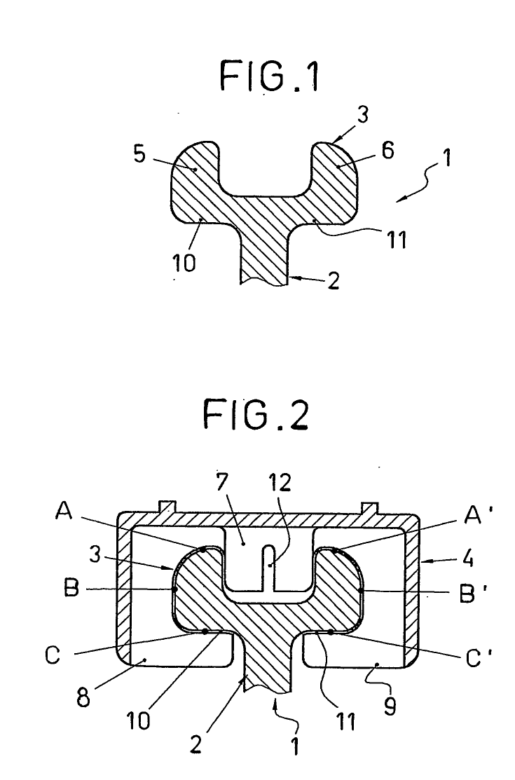

FIG. 1 is a cross-sectional view of the rail of the invention; and

FIG. 2 is a cross-sectional view of the rail in FIG. 1 with the driving member fitted thereto.

A detailed list of the various parts cited in the present patent application is given below:

(1) rail section member;

(2) first longitudinal base portion;

(3) second longitudinal portion abutting the driving member;

(4) driving member;

(5, 6) branches of the U-shaped section of the driving member;

(7) extension of the driving member;

(8, 9) free ends of the driving member;

(10, 11) lower portion of the second longitudinal portion; and

(12) groove wherein the driving cable of the driving member extends.

In FIGS. 1 and 2 the section member of the rail of the present invention has been generally referenced by (1). Said section member of the rail (1) according to the embodiment that is herein described is made of plastic material, for example PA, POM, PBT, PS polypropylene (PP) with 30% of glass fiber, polyethylene (PE) with 30% of glass fiber, or any other suitable plastic material or covered (cold painted or flamed). As it can be seen, specially from FIG. 1, the section member (1) comprises a first longitudinal base portion (2) and a second longitudinal portion (3).

The section member (1) of the rail is associated with a driving member (4), as it can be seen from FIG. 2 in the drawings herein enclosed. Said second longitudinal portion (3) is in sliding contact with said driving member (4) shown in FIG. 2. The driving member (4) is provided with a clamp (not shown) which holds the window pane through the lower edge thereof.

As it can be seen, the second longitudinal portion (3) of the section member (1) has an essentially U-shaped symmetrical cross-section having rounded branches (5, 6). Between said branches (5, 6) a suitable clearance is provided in such a way that an extension (7) of the driving member (4) may be fitted, as shown in FIG. 2.

The configuration of the driving member (4) with said extension (7) fitted into the clearance between branches (5, 7) of the section member of the rail (1) allows to effectively avoid relative rotating movements.

The first longitudinal base portion (2) has a suitable thickness allowing the section member of the driving member (4) to be extended into respective free ends (8, 9) which are in contact with the lower portion (10, 11) of the second longitudinal portion (3).

The configuration of the rail (1) and that of the driving member (4) provides six symmetrical contact areas which have been referenced by (A, B, C, A′, B′, C′) in the sectional views thereof in FIG. 2. This symmetry, in combination with the contact areas derived from the geometry of the rail/driving member assembly (1, 4) advantageously allows to balance the loads of the assembly thus avoiding relative rotation of both elements.

Said extension (7) of the driving member (4) is provided with a groove (12) for receiving the driving cable of the driving member (4).

Once having been sufficiently described what the present invention consists according to the enclosed drawings, it is understood that any detail modification can be introduced as appropriate, provided that variations may alter the essence of the invention as summarised in the appended claims.

1- “SECTION MEMBER FOR PLASTIC RAILS FOR POWER WINDOW DEVICES IN MOTOR VEHICLES” adapted to outwardly slidingly receive a driving member (4) movable along a rail (1) provided with a clamp for holding the lower edge of the window pane of the window pane of the motor vehicle, the section member of said rail (1) comprising a first longitudinal base portion (2) and a second longitudinal portion (3) abutting said driving member (4), characterized in that said second longitudinal portion (3) of the section member (1) has an essentially U-shaped symmetrical cross-section between which branches (5, 6) an extension (7) of said driving member (4) is fitted to avoid relative rotating movements and to maintain the stability of loads in the cable and friction between the driving member and the rail.

2- “SECTION MEMBER FOR PLASTIC RAILS FOR POWER WINDOW DEVICES IN MOTOR VEHICLES” according to claim 1, characterized in that said first longitudinal base portion (2) has a suitable thickness to bring the two free ends (8, 9) of the driving member (4) into abutting relationship with the lower portion (10, 11) of said second longitudinal portion (2).

3- “SECTION MEMBER FOR PLASTIC RAILS FOR POWER WINDOW DEVICES IN MOTOR VEHICLES” according to claim 1, characterized in that said extension (7) of said driving member (4) is provided with a groove (12) for receiving the driving cable of the driving member (4).
